(19) United States
(12) Patent Application Publication
(10) Pub. No.: US 2011/0246216 A1
(43) Pub. Date: Oct. 6, 2011

(54) Online Pre-Registration for Patient Intake

(75) Inventors: Prashant Agrawal, Kirkland, WA (US); Jason R. W. Ramsay, Redmond, WA (US); Pranavakumar Punniamoorthy, Redmond, WA (US); Muzammil Ahmed, Seattle, WA (US); Jeffrey Winter, Seattle, WA (US); Katherine W. Osborne, Kirkland, WA (US); Shawna D. Cooper, Redmond, WA (US); Keith Daniels, Seattle, WA (US); Suzanne Tocco, Bellevue, WA (US); Umesh Madan, Bellevue, WA (US)

(73) Assignee: Microsoft Corporation, Redmond, WA (US)

(21) Appl. No.: 12/751,938

(22) Filed: Mar. 31, 2010

(51) Int. Cl. G06Q 10/00; G06Q 50/00; G06F 17/30

(52) U.S. Cl. 705/2; 707/802; 707/781; 707/E17.005; 707/E17.044

(57) ABSTRACT

Described herein are techniques for enabling a patient to pre-register for a medical visit to a healthcare facility (e.g., a hospital) online. Also described herein are techniques that enable a hospital staff to pre-process a patient's pre-registration intake forms before the patient arrives for the medical visit at the healthcare facility. With some of the described techniques, the patient's pre-registration intake forms may have been customized to match the needs and desires of the healthcare facility, its departments, and/or the healthcare providers (e.g., nurses, physicians, etc.) taking care of the patient during the visit.

### BACKGROUND

A patient arrives at the neurology department of a local hospital a few hours early for an outpatient procedure that should take less than an hour to perform. After a warm greeting by the office staff of the neurology department, the patient is handed a clipboard stuffed with patient-intake forms to fill out. During the hour or two that she spends filling-out the forms, the patient once again verifies her demographic information, struggles to remember specific medical history information, the names and spelling of her current medications, the name of a condition that a relative was recently diagnosed with, and other relevant medical information.

In addition, the patient is bored and annoyed because she has filled-out forms very much like this a few months ago in the endocrinology department just a few floors away in the very same hospital. Of course, the physicians need the patients to fill-out the patient-intake “paperwork” before each procedure in order to obtain current and relevant information.

Healthcare professionals understand that patients dislike filling-out similar “paperwork” each time the patients have a procedure in a hospital. However, a common standard for that paperwork often does not exist because each hospital in a medical system has its own needs, each department in a hospital has its own needs, and each physician in each department has her own needs as well. Furthermore, an omnibus form that asks everything that each healthcare provider desires is likely to overwhelm patients even further.

Presently, no solution exists that relieves the patient from the time-consuming, redundant and error-prone patent-intake process of filling-out paperwork upon arrival for her medical procedure and that satisfies the particular needs of the various healthcare professionals and entities involved in the procedure.

### SUMMARY

Described herein are techniques for allowing a patient to pre-register for a medical visit to a healthcare facility (e.g., a hospital) online. Also described herein are techniques that enable a hospital staff to pre-process a patient's pre-registration intake forms before the patient arrives for the medical visit at the healthcare facility. With some of the described techniques, the patient's pre-registration intake forms are customized to match the needs and desires of the healthcare facility, its departments, and/or the healthcare providers (e.g., nurses, physicians, etc.) taking care of the patient during the visit.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The term “techniques,” for instance, may refer to device(s), system(s), method(s) and/or computer-readable instructions as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an example computing environment that implements techniques to facilitate online pre-registration for patient intake.

FIG. 2 is an example online pre-registration user interface in accordance one or more implementations of the techniques described herein.

FIG. 3 illustrates an example workflow for hospital staff to process an online pre-registration patient-intake form and a user interface for doing the same.

FIGS. 4-6 are flow diagrams of one or more example processes, each of which implements the techniques described herein.

### DETAILED DESCRIPTION

Described herein are techniques for enabling patients to pre-register prior to an upcoming inpatient or outpatient medical visit to a hospital or other healthcare facility. With some of the described techniques, the hospital may pre-process a patient's pre-registration intake forms before the patient arrives for the upcoming medical visit. With some of the described techniques, the pre-registration patient-intake forms are customized to match the needs and desires of the hospital, its departments, and/or the healthcare providers (e.g., nurses, physicians, etc.) taking care of the patient during the visit.

Typically, healthcare facilities (e.g., hospitals, urgent care facilities, rehabilitation centers, doctors' offices, etc.) do not offer a way for patients to pre-register online before arriving at the healthcare facility for a scheduled medical appointment. This leads to the situation where the patient often needs to fill out multiple demographic, insurance, and other medical forms at the facility, such as the hospital. The techniques described herein offer a way for the hospital to receive this information from the patient prior to admission. This streamlines the patient intake process for hospital staff and the patient. Additionally, it is often difficult for a patient to recall all of the information needed on these forms when the patient is already at the hospital. By allowing the patient time to fill out this information prior to the visit (e.g., from the comfort of her home), the patient is more likely to completely and accurately complete the forms than if the patient were to complete the “paperwork” in a hospital waiting room. The described techniques are safer as well. With more accurate and complete information, the healthcare provider is better prepared to provide better and safer care to the patient.

While some of the techniques described below are illustrated in the context of hospitals, these techniques apply to any other health care facilities, such as urgent care facilities, rehabilitation centers, doctors' offices, and any other environment where a patient may seek medical care of any form.

In some implementations described below, a hospital provides online access to customized and pre-populated pre-registration forms for patient intake for an upcoming hospital visit. Said another way, the hospital gives a patient access to customized patient-intake forms that may be pre-populated with the patient's health data that is imported from repository of the patient's health data. The forms are customized to match the needs of the healthcare provider, which may include a hospital system, a particular hospital, a particular department of the hospital, and/or a particular medical professional (such as a doctor, physician assistant, nurse practitioner, therapist, etc.). The forms are pre-populated by pulling in the patient's health data from a network-accessible, patient-controlled repository for health data. Typically, that repository is a third-party database that is separate from the hospital and the user, but is accessible by the user and/or patient via a computing-communications network (such as the Internet).

The one or more described techniques are also directed towards scenarios when a patient has a scheduled medical visit at a healthcare facility (perhaps one of many in a medical system). The upcoming visit is typically with a particular department and with one or more particular doctors (or other medical professionals). The departments may include (by way of example and not limitation): cardiology, vascular, endocrinology, gastroenterology, hematology, immunology, sports medicine, nephrology, urology, neurology, obstetrics, gynecology, oncology, ophthalmology, otolaryngology, pediatrics, neonatology, pulmonary, rheumatology, etc. The patient's scheduled medical visit may include any pre-planned outpatient or inpatient appointments or procedures. While implementations are described herein in terms of a patient's scheduled medical visit, other implementations may include a non-scheduled (e.g., urgent or emergency) medical visit.

### Example Computing Infrastructure

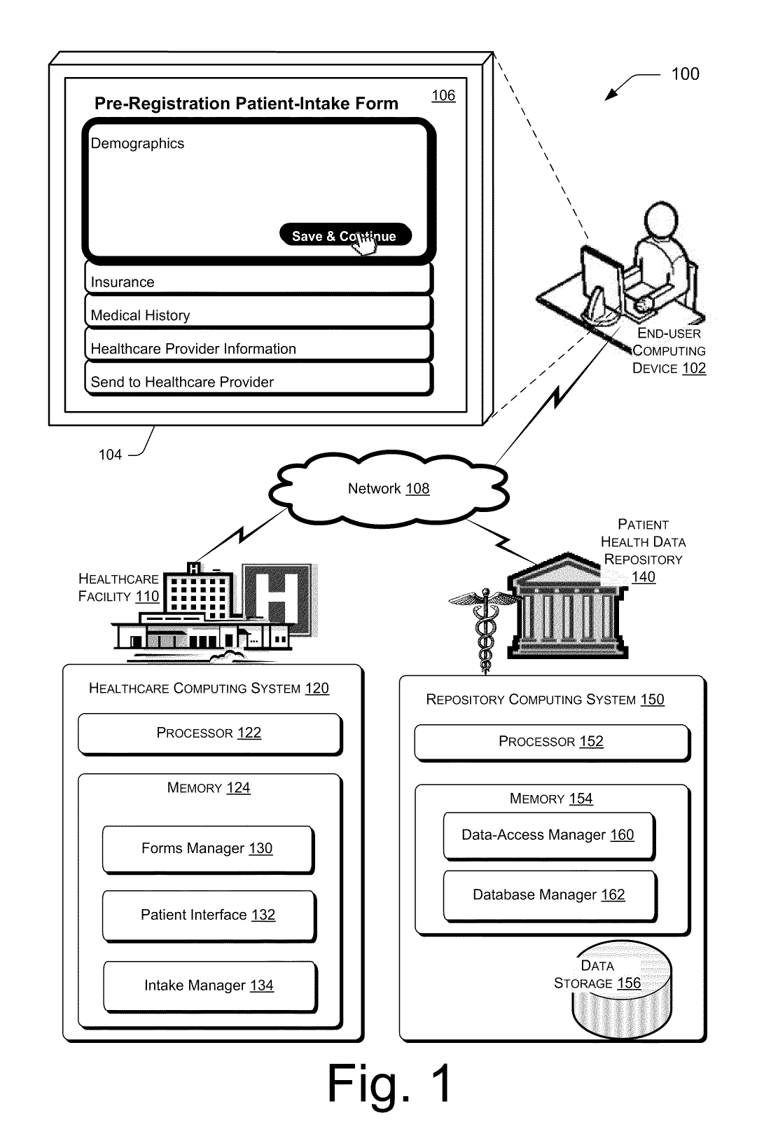

FIG. 1 illustrates an example computing infrastructure 100 that may implement the described techniques for offering online access to customized and pre-populated, pre-registration forms for patient intake for an upcoming medical visit to a healthcare facility. The infrastructure 100 may include at least one end-user computing device 102 having a display screen 104 with an example user-interface (UI) 106 allowing a user to pre-register for a medical visit by completing one or more patient intake forms.

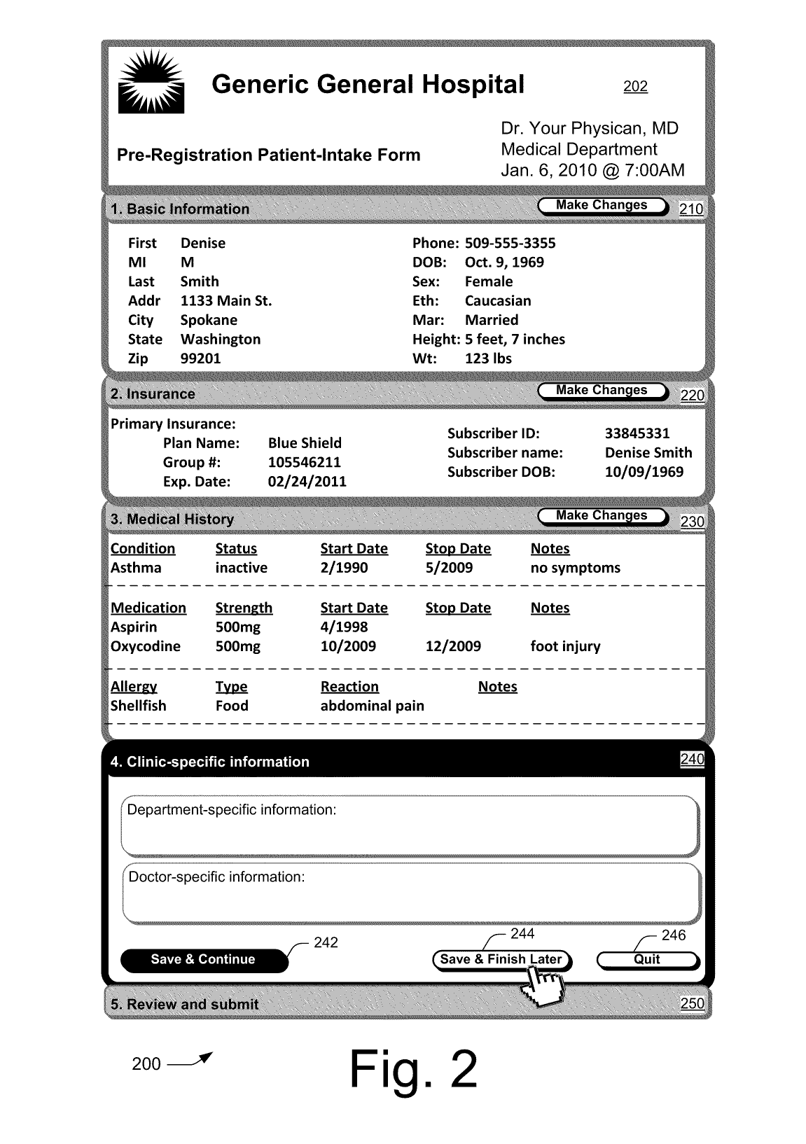

This UI 106 shows five example categories of an example pre-registration form: Demographics, Insurance, Medical History, Healthcare Provider (e.g., doctor or hospital) Information, and a “Send to” option for sending the information to the healthcare provider. The UI 106 is shown here in an “accordion” fashion, where each category of the form may be compressed or expanded. As shown, all categories of UI 106 are shown compressed to some degree. The UI is discussed more fully with regard to the description of FIG. 2.

FIG. 1 shows that the infrastructure 100 may also include a communications network 108 coupling the end-user computing device 102 with a healthcare facility 110 and a patient health data repository 140.

The end-user computing device 102 is typically a computer that is connected via a network 106 to the healthcare facility 110 and the patient health data repository 140. The computing device 102 has processors, memories, storage systems, and input/output subsystems, such as a keyboard, mouse, monitor, speakers, etc. The end-user computing device 102 typically is running one or more application programs, such as a Web browser, to view and interact with the example pre-registration UI 106. The computing device 102 may be mobile phone, a smart phone, a tablet, or any other suitable computing device.

The communications network 108, meanwhile, represents any one of or a combination of multiple different types of networks, interconnected with each other and functioning as a single large network (e.g., the Internet, the Web, or an intranet). Physically, the network 108 may include wire-based networks (e.g., Ethernet, cable, dial-up telephone cabling, etc.) and/or wireless networks (e.g., local wireless network hub, wireless hotspot, mobile, cellular, satellite, etc.).

In this example, the network-coupled healthcare facility 110 represents a hospital. It should be understood that the healthcare facility 110 includes also other kinds of healthcare facilities that have intake processes for inpatient or outpatient visits. Such healthcare facilities include (by way of example and not limitation): clinics, medical centers, health institutions, centers for medical diagnosis, treatment and/or therapy, general hospitals, specialized hospitals, rehabilitation centers, infirmaries, and the like.

As depicted, the hospital 110 includes a healthcare computing system 120. While the healthcare computing system 120 services the hospital 110, the system may physically exist partially or fully offsite from the hospital itself. Also, while shown here as one computing system, the healthcare computing system 120 is likely to consist of multiple computing devices, systems, and subsystems that are physically located across multiple locations in the hospital 110 and often many other hospitals and sites.

As illustrated, the healthcare computing system 120 includes one or more processors 122 and one or more memories 124. The healthcare computing system 120 includes multiple components, such as a forms manager 130, a patient interface 132, and an intake manager 134. The healthcare computing system 120 may also have storage systems, other memories, and input/output subsystems such as a keyboard, mouse, monitor, speakers, etc. Indeed, the healthcare computing system 120 may include one or more data storage subsystems and distributed computing and/or network access mechanisms through which other hospital terminals or computing devices may gain access.

The forms manager 130 manages, customizes, and generates pre-registration patient-intake forms (like that seen in UI 106). Using the forms manager 130, a hospital staffer may decide which forms and form fields are displayed to the user based on the various factors, such as facility, department, and physician from whom the patient is receiving treatment. In this way, the user receives a custom experience (via the UI 106 for example) that is centrally managed by the hospital. This approach is more efficient, allowing each department and doctor to have their own intake forms, which are centrally collected, managed, and presented in a single UI to the patients. With a user-friendly interface, a non-technical staffer may handle the form association process. In the form association process, a non-technical staffer uses a UI to select premade and/or default forms or form parts to assemble a customized form.

Using the forms manager 130, each hospital may use standard pre-generated forms or may create new forms specific to a particular healthcare facility (e.g., Hospital1 or Hospital2 in the same hospital system), particular departments (e.g., oncology, obstetrics, neurology), and particular physicians (e.g. Dr. Jones), or other healthcare providers.

The patient interface 132 selects the particular patient-intake form presented to the user (e.g., in UI 106) and populates the form with data. Based on the information entered during the initial phases of pre-registration, the patient interface 132 selects or generates a pre-registration form for the patient to fill out. In addition, during this process the form may be pre-populated with some of the patient's health-related data pulled from the network-coupled patient health data repository 140.

The intake manager 134 handles the patient-intake procedure once the user has submitted a populated pre-registration patient-intake form. During this intake procedure, the intake manager 134 helps track the queue of patient intakes that have been processed or are being processed. Upon the completion of the intake procedure, the patient intake is completed and the patient is ready for the upcoming medical visit.

FIG. 1 also shows the network-coupled patient health data repository 140. The repository 140 may be part of an online, open platform where people may gather, store and manage their families' health data, and allow sharing of that data with their physicians and other healthcare providers. Such a platform gives people the means to play a more active role in their health care by providing access to tools to compile information, track and monitor progress, complete health-focused tasks, educate themselves about health issues, and connect disparate elements of their care. The repository 140 offers a central place to build health histories that the patient (or perhaps someone in the patient's family) controls and manages.

As depicted, the repository 140 includes a repository computing system 150. While shown here as one computing system, the repository computing system 150 is likely to consist of multiple computing devices, systems, and subsystems that are physically located across multiple network-coupled sites.

As illustrated, the repository computing system 150 includes one or more processors 152, one or more memories 154, and one or more data storage subsystems 156. The repository computing system 150 also includes multiple components, such as a data-access manager 160 and a database manager 162.

The data-access manager 160 handles attempts to access data stored in the repository 140. Typically, the user is the patient who is pre-registering for her own upcoming medical procedure. However, that is not always the case. For example, in some instances the user may be a parent, spouse, or some other family member who is making medical decisions for the patient. It is, of course, common for a mother or father to arrange for a medical appointment for her or his child. In these instances, the user is a trusted person and may have full access to the patient's health-related data in the patient-controlled repository 140. While this user is not literally the patient, the trusted relationship allows the user to have access like the patient. Therefore, unless the context indicates differently, the term “patient-controlled,” as used herein, includes a highly trusted user who might not be the patient. The highly trusted user may include, for example, those people designated by the patient as authorized to act on behalf of the patient or by a legal entity of the patient such as a guardian or court, or by law.

There is another category of user herein called a “limited-access” user. The limited-access user is authorized to access the patient's health-related data in the repository 140 for the purpose of reading the data only. The limited-access user cannot write to or update the patient's health-related data in the repository 140. A limited-access user may be useful when the trust relationship is limited as well. For example, a nanny or a daycare employee may have authority to pull in a child patient's existing health-related data, but they may be prohibited from changing that data. In another example, a user may be prohibited from changing data when the user accesses the information from a non-trusted location where a risk of exposing the patient's data to unfettered intrusion may exist.

The database manager 162, meanwhile, manages one or more databases of health-related data for patients. The databases are stored on the one or more data storage subsystems 156, for example. The database manager 162 provides access to a user based upon the degree of access allowed by the data-access manager 160.

As illustrated, the components are software modules of computer-executable instructions residing in a memory (such as memories 124 or 154) and are being executed, as needed, by a processor (such as processors 122 or 152). In general, the computer-executable instructions are instructions executed by one or more computers, computing devices, or the processors of a computer. While shown here as modules, the components may be embodied as hardware, firmware, software, or any combination thereof. Also, while shown here residing on a single computing device (i.e., the healthcare computing system 120 or the repository computing system 150), the components may be distributed across many computing devices in the distributed system or network. Also, some example components (e.g., the patient interface 132) shown with one system (e.g., the healthcare computing system 120) may be implemented on other systems (e.g., repository computing system 150) in alternatively implementations.

### Pre-Registration Form for Patient Intake

FIG. 2 shows an example pre-registration user interface (UI) 200 in accordance with at least one implementation of the described techniques. In short, the pre-registration user interface (UI) 200 is called the patient-intake form. While FIG. 2 illustrates an example form, other implementations may arrange the data and fields for entering the data differently.

As shown, the patient-intake form 200 has a heading 202 with a logo and name of the healthcare facility (e.g., “Generic General Hospital”). The heading 202 also includes visit-specific information about the patient's upcoming medical visit. In this example, the patient is scheduled to see “Dr. Your Physician, MD,” while the scheduled department in the healthcare facility is “Medical Department” and the scheduled date and time is “Jan. 6, 2010 @ 7:00 AM.” Utilizing another user interface, the user may have entered the visit-specific information that now appears in the heading 202 of the patient-intake form 200. Alternatively, the hospital may pre-specify the visit-specific information for the user. The visit-specific information may influence exactly which form is selected to be presented to the user as the patient-intake form 200. Customized forms may be generated based upon many factors related to the visit. Those factors may include, for example, the healthcare facility, the department at the facility, and the doctor (or other healthcare provider).

The example patient-intake form 200 includes five sections: a basic information section 210, an insurance section 220, a medical-history section 230, a clinic-specific information section 240, and a review-and-submit section 250. Of course, other implementations may include more sections, less sections, different sections, and/or may divide the same patient information in differing ways.

The basic information section 210 requests basic information about the patient, sometimes referred to as demographic information. Because of this, the basic information section 210 may also be called the demographic section. FIG. 2 illustrates examples of such information, including the patient's name, address, telephone number, date of birth (DOB), sex, ethnicity, marital status, height, and weight. Of course, the basic information section 210 may include a plethora of other patient-specific health data, such as blood type, organ donor status, family identification and relationships, age, language preference, social security number, other identification number, hearing or sight impairment, emergency contact information, employer, pregnancy status, guardian information, and the like. In general, the basic information section 210 may act as a default category for information that does not fit into a different section or category.

The insurance section 220 includes information about the patient's health insurance policies. The insurance section 220 shows examples of some of the relevant information about insurance. That includes, for example, plan name, group number, plan's expiration date, the subscriber's identification, the subscriber's name, and the subscriber's date of birth. Similar information may be provided about other insurance policies. This includes both private and public policies. In addition, if the patient is self-insured, then the details about the self-insurance are recorded in this section.

The medical-history section 230 includes information about the patient's medical history, which is sometimes called the patient's anamnesis. The type of medical-history information that may be listed here include (by way of example and not limitation): past medical conditions (including major illnesses, previous surgeries, chronic conditions, and childhood diseases), present and past medications, allergies, details about past medical visits, family medical history, and social history (e.g., recent foreign travel and use of tobacco and alcohol).

The clinic-specific information section 240 includes information that has been specifically requested by or is otherwise relevant to the healthcare facility, the department at the facility and/or the doctor involved in the particular upcoming medical visit. As shown in FIG. 2, the clinic-specific information section 240 is the current active section in the patient-intake form 200. The other sections have a user-selectable button labeled “Make Changes” In this example, when the user selects that button for a particular section, that particular section becomes active.

Active section 240 is presented in bold and includes additional options. First, the user can make changes to the data in the active section. Second, the user has the option to save the data in the section and continue entering data by selecting an option like a “save & continue” button 242. Third, the user has the option to put the data-entry on hold for the moment, return later, and pick up where she left off. When the user selects a “save and finish later” button 244, a draft of the in-progress data for the patient-intake form 200 is saved. Fourth, the user may select a “quit” button 246 to close out the form.

When the user views the review-and-submit section 250, the user may review the information in select ones or all of the sections. When satisfied, the user may submit the information in the patient-intake form 200. Before the user enters any data into the patient-intake form 200 and typically before the user views any section of data, the patient-intake form 200 may be pre-populated. The form is pre-populated with patient information pulled from the patient-controlled repository 140 that is storing the patient's health-related data. Once the user selects the submit option, the patient-intake form 200 is populated and the hospital 110 may begin its patient-intake procedures.

Alternatively, the user may have the option to print a hardcopy of a populated version of the patient-intake form 200. In this situation, the user sends (e.g., email, fax, or postal mail) the hardcopy to the hospital or brings the hardcopy with her when she arrives for the medical visit.

### Patient Intake Workflow

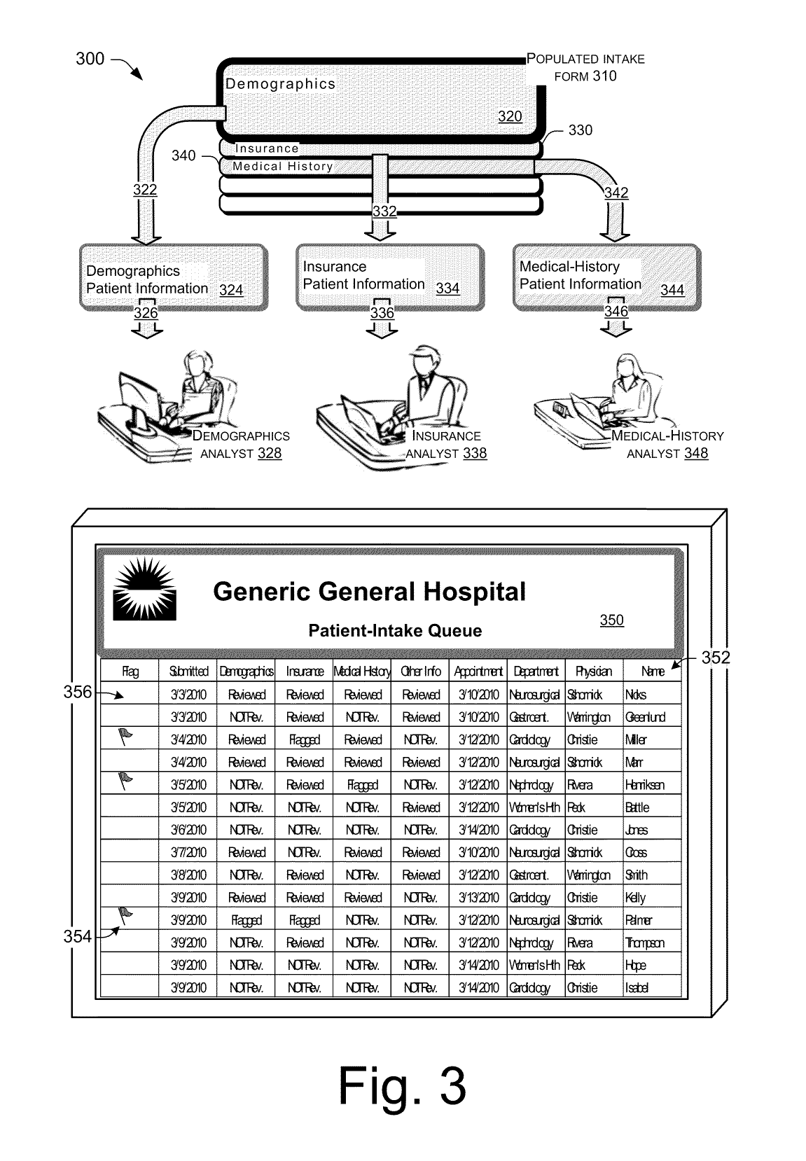

FIG. 3 shows an example workflow 300 for the hospital staff to process a populated online pre-registration patient-intake form 310. FIG. 3 also shows a patient-intake queue user interface (UI) 350 for doing the same. Both the example workflow 300 and the patient-intake queue UI 350 are shown and described in accordance with one or more implementations of the techniques described herein.

Three sections or categories of patient information from the populated patient-intake form 310 are highlighted and will be discussed herein. Those categories include demographics 320, insurance 330, and medical history 340. Of course, the patient information may be categorized into other categories, and these three categories are chosen simply for illustrative purposes.

After the user submits the fully populated patient-intake form 310, the healthcare computing system 120 segregates or divides the categories. The example workflow 300 shows arrows 322, 332, and 342 leading from the relevant sections/categories of the populated patient-intake form 310 to their associated segregated patient information boxes 324, 334, and 344, respectively. The arrows 322, 332, and 342 represent the segregation action that is part of the example workflow 300. The patient information, segregated into different categories, is shown by separate boxes for each illustrative category of patient information. As represented by arrows 326, 336, and 346, the categorized patient information is exposed to an appropriate patient-information analyst.

More specifically, the demographic patient information 324 is segregated from the populated patient-intake form 310 (as represented by arrow 322) and exposed to a demographics analyst 328 (as represented by arrow 326). Similarly, the insurance patient information 334 is segregated from the populated patient-intake form 310 (as represented by arrow 332) and exposed to an insurance analyst 338 (as represented by arrow 336). Likewise, the medical-history patient information 344 is segregated from the populated patient-intake form 310 (as represented by arrow 342) and exposed to a medical-history analyst 348 (as represented by arrow 346).

As shown here, the patient-information analysis may be performed, at least in part, by humans. Typically, the patient-information analysts (e.g., demographics analyst 328, insurance analyst 338, and medical-history analyst 348) are employed by or are agents of the healthcare facility, department, or doctor for the patient's upcoming medical visit. Some portion of the information may be analyzed by a computer, (especially where information is compared and confirmed across databases), but for other information, it may be desirable to have an experienced medical staffer review the information.

Each of the patient-information analysts is responsible for reviewing, approving, analyzing, confirming, and/or flagging a particular category of patient information. While authorized to view and manage the data and information segregated into her responsible category, each of the patient-information analysts is limited to viewing and managing only the category or categories for which they are responsible. For example, the demographics analyst 328 is limited to accessing (e.g., viewing, editing, updating, and managing) the demographics patient information 324. However, the demographics analyst 328 is prohibited from accessing the insurance patient information 334 and the medical-history patient information 344. By limiting the access to a need-to-know basis, the patient's personal information is better protected than it would be otherwise.

The patient-intake queue UI 350 is an example of the UI that the patient-information analysts may be using. It may be produced by the healthcare computing system 120. The UI 350 shows a queue of patient-intake submissions that have been processed or are in the process of being reviewed and analyzed by the patient-information analysts. Each row in the UI 350 represents one patient-intake procedure in process (or completed). The heading row 352 shows the labels of the example information presented in each column of each row of the UI 350. Those labels include flag, date submitted, demographics category, insurance category, medical history category, other information category, appointment date, department, physician, and patient's name. Of course, other information may be shown in other implementations.

A queued intake is flagged with a “flag,” as shown at 354, when a patient-information analyst marks the queued intake for further investigation. This may occur if additional information is needed or the accuracy of the information provided is in question, for example.

The category of each queued intake is marked as “Reviewed” or “NOT reviewed” by the patient-information analyst responsible for that category. In some implementations, there may be separate category called “Flagged” that indicates a partial review, but that additional attention is needed. Of course, other markings are available such as “Sufficient,” “Insufficient,” “Approved,” “NOT approved,” “Confirmed,” “NOT confirmed,” “Complete,” “NOT Complete,” etc. Once each of the categories has been reviewed, the queued intake is approved, as exemplified by intake 356, or simply completed. An approved or completed intake may be removed from the queue once done or, alternatively, once the visit has occurred.

### Example Processes

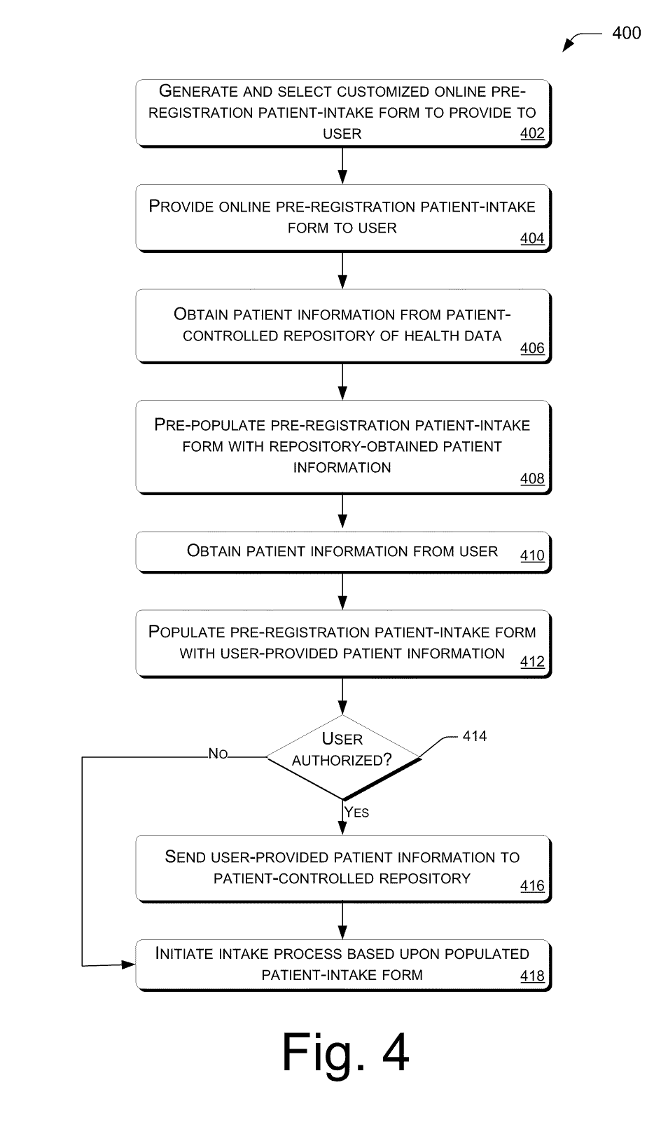

FIGS. 4-6 are flow diagrams illustrating example processes 400, 500, and 600 that implement the techniques described herein for online pre-registration for a patient making an inpatient or outpatient visit of a healthcare facility. The example UIs (e.g., 106, 200, and 350) shown in FIGS. 1-3 and described above are the result of or are utilized by the example processes 400, 500, or 600.

Each of these processes is illustrated as a collection of blocks in a logical flow graph, which represents a sequence of operations that can be implemented in hardware, software, firmware, or a combination thereof. In the context of software, the blocks represent computer instructions stored on one or more computer-readable storage media that, when executed by one or more processors of such a computer, perform the recited operations. Note that the order in which the processes are described is not intended to be construed as a limitation, and any number of the described process blocks can be combined in any order to implement the processes, or an alternate process. Additionally, individual blocks may be deleted from the processes without departing from the spirit and scope of the subject matter described herein.

FIG. 4 illustrates the example process 400 for online pre-registration for a patient making an inpatient or outpatient visit of a healthcare facility. The example UIs 106 of FIG. 1 and 200 of FIG. 2 are utilized as part of the process 400. In addition, the process 400 is performed, at least in part, by a computing device or system, which includes, for example, the healthcare computing system 120 of FIG. 1. Of course, in other implementations the example process 400 may be performed by the end-user computing device 102 of FIG. 1, the repository computing system 150 of FIG. 1, or some combination thereof. The computing device or system is configured to facilitate a patient intake for the medical visit by the patient of the healthcare facility. The computing device or system so configured qualifies as a particular machine or apparatus.

As shown here, the process 400 begins with operation 402, where the computing device generates customized online pre-registration patient-intake forms based upon specific needs or desires for particular healthcare entities, which include healthcare facilities, departments at the healthcare facilities, and healthcare providers, for example. This customization may be performed, at least in part, based upon input by healthcare staff. In addition, operation 402 includes selection of the appropriate customized form based upon specific information provided by the user and/or patient. That specific information identifies the upcoming medical visit and includes, for example, the scheduled day and/or time of the medical visit, the scheduled location of the medical visit, the scheduled healthcare facility that will host the medical visit, the responsible departments at the healthcare facility, and the responsible healthcare providers (e.g., doctors, nurses, physician assistant, etc.).

At operation 404, the computing device provides the selected customized pre-registration patient-intake form to the user. The form may be provided online over a communications network, like the Internet. The form may be provided as one or more web pages, although other user interfaces (UIs), such as the UIs 106 and 200 shown in FIGS. 1 and 2, may additionally or alternatively be implemented.

At operation 406, the computing device gathers information about the patient (“patient information”) from a network-coupled patient-controlled repository of the patient's health-related data, such as repository 140.

At operation 408, the pre-registration patient-intake form is pre-populated with the patient information obtained from the network-coupled patient-controlled repository of the patient's health-related data. At this point, the user sees the customized pre-registration patient-intake form (in, for example, a Web browser) with some or all of the data fields already populated (i.e., pre-populated).

The user fills in blank data fields and/or updates already populated fields. In response, the computing device, at operation 410, receives the new and/or updated patient information from the user.

At operation 412, the computing device populates the pre-registration patient-intake form with the new and/or updated user-provided patient information. The user-provided information includes health-related data about the patient. Also, during operation 412, the computing device may also update the patient's data stored at the network-coupled patient-controlled repository with the new and/or updated user-provided patient information. This way the network-coupled patient-controlled repository has the most recent data, which may be used to pre-populate another pre-registration intake form for this healthcare facility or any other on the network.

Typically, the user is the patient who is pre-registering for her own upcoming medical procedure. However, that is not always the case. For example, in some instances the user may be a parent, spouse, some other family member, or any caregiver who is making medical decisions for the patient. In these instances, the user is a trusted person and may have full access to the patient's health-related data in the patient-controlled repository.

There is another category of user called a “limited-access” user herein. The limited-access user is authorized to access the patient's health-related data in the repository for the purpose of reading the data. However, the limited-access user cannot write to or update the patient's health-related data in the repository. A limited-access user may be useful when the trust relationship is limited as well.

At operation 414, the computing device determines if the user is authorized to write new data or update existing data in the patient's health-related data stored by the patient-controlled repository. If the user is the patient or a member of the patient's trusted circle of users, then the user is authorized. In that case, the process proceeds to the next operation where data is updated at the repository. Otherwise, the process jumps to operation 418.

At operation 416, the computing device sends the user-provided patient information to the patient-controlled repository (e.g. the patient health data repository 140). At this point, the repository may write new data or update existing data in the patient's health-related data based upon that user-provided patient information. Alternatively, the computing device may send the user-provided patient information and user-identifying information to the repository. With this information, the repository may make its own determination about whether to write/update the patient's health-related data based upon that user-provided patient information.

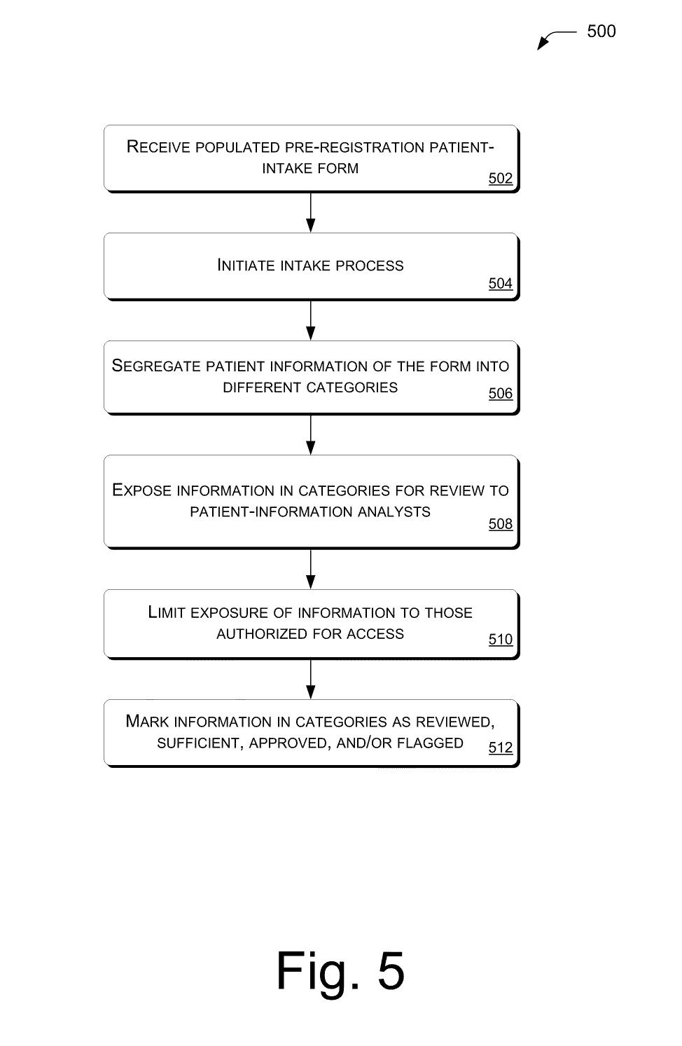

At operation 418, the computing device initiates the intake process based upon populated patient-intake form. Indeed, this operation starts the process 500 shown in FIG. 5.

FIG. 5 illustrates the example process 500 for online pre-registration for a patient making an inpatient or outpatient visit of a healthcare facility. The example UI 350 of FIG. 3 may be utilized as part of the process 500. In addition, the example workflow 300 of FIG. 3 depicts part of the process 500. Also, the process 500 is performed, at least in part, by a computing device or system, which includes, for example, the healthcare computing system 120 of FIG. 1. Of course, in other implementations, the process 500 may be performed by the end-user computing device 102 of FIG. 1, the repository computing system 150 of FIG. 1, or some combination thereof. The computing device or system is configured to facilitate a patient intake for the medical visit by the patient of the healthcare facility. The computing device or system so configured qualifies as a particular machine or apparatus.

As shown here, the process 500 may pick up where the process 400 of FIG. 4 leaves off. The process 500 begins with operation 502, where the computing device receives one or more populated pre-registration patient-intake forms, such as the one created as part of the process 400 of FIG. 4. Typically, the computing device receives this information via a communications network, such as the network 108 of FIG. 1. The patient-intake forms are for an upcoming medical visit by the patient of a healthcare facility (such as hospital 110 of FIG. 1). The patient intake forms may have been populated with patient information relevant to that medical visit.

With the forms received, the patient-intake procedure begins, at operation 504, in earnest by the hospital staff and computing systems. The purpose of the intake-process is to confirm that all relevant patient information needed or desired by the healthcare professionals for the patient's visit is gathered.

At operation 506, the computing device divides or segregates the patient information from the forms into different categories. Examples of relevant categories include demographics, health insurance, medical history, and clinic-specific information requests.

At operations 508 and 510, the computing device exposes the patient information in each category for review by patient-information analysts while limiting exposure of the information to only those authorized to access particular information and/or categories. For example, there may be differing levels of access for clinical staff versus non-clinical staff. The non-clinical staff may be prevented from seeing the medical history, but instead is allowed to view insurance information.

In one or more implementations, the patient-information analysis is performed, at least in part, by humans. Some portion of the information may be analyzed by a computer (especially where information is compared and confirmed across databases), but for other information it may be desirable to have an experienced medical staffer review the information.

At operation 512, based upon input from the patient-information analysts, the computing device marks the information and/or the categories as having been reviewed, sufficient, completed, approved, and/or flagged. Reviewed information is information that the patient-information analyst has reviewed. Sufficient information is information that the patient-information analyst has reviewed and determined to be sufficient to meet a minimum threshold for completeness. Approved or completed information is information that the patient-information analyst has reviewed and deemed to be both complete and accurate (as far as can be determined). Flagged information is information that the patient-information analyst has reviewed and determined to need additional attention. When information is flagged, typically a hospital staffer will need to follow-up with the patient to get the missing, incomplete, or inaccurate information. Once all the flagged issues have been resolved and all of the categories have been marked as reviewed, sufficient, or approved, the patient-intake procedure is complete.

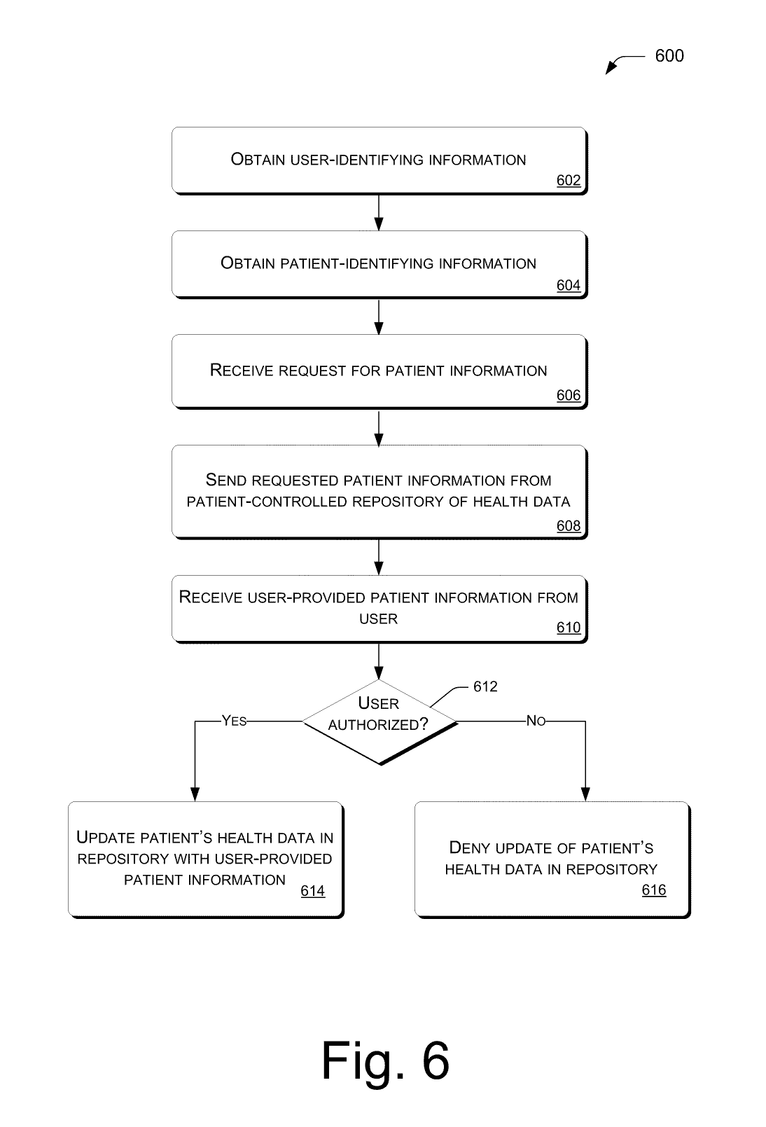

FIG. 6 illustrates the example process 600 for online pre-registration for a patient making an inpatient or outpatient visit of a healthcare facility. The process 600 is performed, at least in part, by a computing device or system, which includes, for example, the repository computing system 150 of FIG. 1. Of course, in other implementations, the process 500 may be performed by the end-user computing device 102 of FIG. 1, or the healthcare computing system 120 of FIG. 1, or some combination thereof. The computing device or system is configured to facilitate a patient intake for the medical visit by the patient of the healthcare facility. The computing device or system so configured qualifies as a particular machine or apparatus.

As shown here, the process 600 begins with operation 602, where the computing device gets information that identifies the user. Generally, this may be called user-specific information. The user may be using an online pre-registration patient-intake form provided by the healthcare computing system 120. When the user identifies herself to the healthcare computing system 120, that information may also be conveyed to the repository computing system 150, as well. Alternatively, an independent user-identification process may be performed by the repository computing system 150.

At operation 604, the computing device obtains information that identifies the patient. Generally, this may be called patient-specific information. The user may be working on an online pre-registration patient-intake form provided by the healthcare computing system 120 of FIG. 1. When the user identifies the patient (who may also be the user) to the healthcare computing system 120, that information may be further conveyed to the repository computing system 150 of FIG. 1. Alternatively, an independent patient-identification process may be performed by the repository computing system 150.

At operation 606, the computing device receives requests for specific patient information to be pulled from the patient-controlled repository of health-related data about the patient. These requests may be generated by instructions embedded in the online pre-registration patient-intake form provided by the healthcare computing system 120 to the user.

In response to those requests, the computing device, at operation 608, sends the requested patient information from patient health data repository 140 of FIG. 1. Typically, the online pre-registration patient-intake form is pre-populated with the requested patient information (at least to the extent that such information is available from the network-coupled patient-controlled repository of the patient's health-related data). The user updates the form with new or different patient information and that information is sent to the repository computing system 150.

After the computing device receives, at operation 610, the user-provided patient information, the device determines, at operations 612, whether the user is authorized to update the patient's records in the patient health data repository 140. If the user is the patient or a member of the patient's trusted circle of users, then the user is authorized.

If the user is authorized, then the computing device, at operation 614, updates the patient's health data in repository 140 with the user-provided patient information. Otherwise, at operation 616, there is no update of the patient's health data in repository 140 with the user-provided patient information because the user is not authorized to make such updates.

### Concluding Notes

As used in this application, the terms “component,” “module,” “system,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of example, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include, but are not limited to, magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more”, unless specified otherwise or clear from context to be directed to a singular form.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

We claim:

1. A method that facilitates online pre-registration for a medical visit to a healthcare facility by a patient, the method comprising:
providing, over a network, a patient intake form to a user;
obtaining, via the network, patient information from a repository of health-related data that is controlled at least in part by the patient;
pre-populating the patient intake form with the patient information from the repository;
after the pre-populating, receiving information regarding a health of the patient from the user; and
populating the patient intake form with the information regarding the health of the patient received from the user.

2. A method as recited in claim 1 further comprising sending at least some of the information regarding the health of the patient received from the user to the repository to enable the repository to update the health-related data about the patient stored by the repository.

3. A method as recited in claim 1 further comprising:
determining that the user is authorized to update data in the repository; and
in response to the determining, sending at least some of the information regarding the health of the patient received from the user to the repository to enable the repository to update the health-related data about the patient stored by the repository.

4. A method as recited in claim 1, wherein the user is also the patient.

5. A method as recited in claim 1 further comprising:
receiving the populated patient intake form for the medical visit by the patient of the healthcare facility; and
determining whether the patient information from the repository and the information regarding the health of the patient received from the user of the populated patient intake form is sufficient for the medical visit to the healthcare facility by the patient.

6. A method as recited in claim 1 further comprising:
before the providing, obtaining information that is specific to the medical visit from the user; and
based at least in part upon the obtained visit-specific information, selecting the patient intake form to provide to the user.

7. A method as recited in claim 1 further comprising:
before the providing:
obtaining information that is specific to the patient from the user, the patient-specific information including information identifying the patient;
obtaining information that is specific to the medical visit from the user, the visit-specific information including one or more of a scheduled time of the medical visit, a scheduled location of the medical visit, a scheduled healthcare facility that hosts the medical visit, a responsible department at the healthcare facility, or a responsible healthcare provider for the medical visit; and
based at least in part upon the obtained visit-specific information, selecting the patient intake form to provide to the user.

8. A method as recited in claim 1 further comprising.
generating customized patient intake forms based at least in part upon healthcare facilities, departments at the healthcare facilities, and healthcare providers;
before the providing, obtaining information that is specific to the medical visit from the user, the visit-specific information including a scheduled healthcare facility that hosts the medical visit, a responsible department at the healthcare facility, and a responsible healthcare provider for the medical visit;
based upon the obtained visit-specific information, selecting the patient intake form from amongst the generated customized patient intake forms.

9. A method as recited in claim 1, the medical visit by the patient of the healthcare facility having been scheduled before the providing but scheduled to occur after the populating.

10. A method as recited in claim 1, wherein the patient information from the repository includes health-related data about the patient selected from a group consisting of a demographic of the patient, health insurance of the patient, symptoms of the patient, family health history associated with the patient, allergies of the patient, existing medical conditions of the patient, medications taken the patient, and other medical history data of the patient.

11. One or more computer-readable media storing processor-executable instructions that, when executed, cause one or more processors to perform operations, the operations comprising:
receiving, over a network, a patient intake form for a medical visit by a patient of a healthcare facility, the patient intake form being populated with patient information relevant to the medical visit by the patient;
segregating the patient information of the populated patient intake form into multiple categories;
exposing for review the patient information of each of the segregated categories to one or more patient-information analysts; and
after review by the one or more patient-information analysts, indicating that the patient information of each of the multiple categories has been reviewed.

12. One or more computer-readable media as recited in claim 11, wherein the operations further comprise flagging the patient information of each of the multiple categories where the one or more patient-information analysts indicate that the patient information is insufficient for the medical visit by the patient of the healthcare facility.

13. One or more computer-readable media as recited in claim 11, wherein the operations further comprise approving the patient intake form for the medical visit by the patient of the healthcare facility after each of the multiple categories have been reviewed.

14. One or more computer-readable media as recited in claim 11, wherein the operations further comprise determining whether the patient information of the populated patient intake form is sufficient for the medical visit by the patient of the healthcare facility.

15. One or more computer-readable media as recited in claim 11, wherein the one or more patient-information analysts are human users.

16. One or more computer-readable media as recited in claim 11, wherein the exposing limits exposure of the patient information to one or more patient-information analysts authorized to view the exposed patient information.

17. One or more computer-readable media as recited in claim 11, wherein the operations further comprise preventing exposure of the patient information of a specific category of the multiple categories from anyone not authorized to access patient information segregated into that specific category.

18. One or more computer-readable media storing processor-executable instructions that, when executed, cause one or more processors to perform operations, the operations comprising:
obtaining, over a network, user-specific information from a user of one or more computing devices configured to facilitate a patient intake for a medical visit by a patient of a healthcare facility;
obtaining patient-specific information from the user, the patient-specific information including information identifying the patient;
receiving, over the network, a request for patient information from a patient-controlled repository of health-related data about the patient;
sending the requested patient information to pre-populate one or more patient intake forms with repository-provided patient information; and
receiving, via the network, user-provided patient information from the user, the user-provided information including health-related data about the patient.

19. One or more computer-readable media as recited in claim 18, wherein the operations further comprise:
determining that the user is authorized to update data in the patient-controlled repository of health-related data about the patient; and
in response to the determining, updating at least some of the health-related data about the patient stored in the patient-controlled repository based at least in part upon the received user-provided patient information.

20. One or more computer-readable media as recited in claim 18, wherein the operations further comprise:
determining that the user is authorized to update data in the patient-controlled repository of health-related data about the patient;
in response to the determining, updating at least some of the health-related data about the patient stored in the patient-controlled repository based at least in part upon the received user-provided patient information; and
providing, to another user who is authorized to access data in the patient-controlled repository of health-related data about the patient, access to the updated health-related data about the patient stored in the patient-controlled repository.
